(19) United States
(12) Patent Application Publication
(10) Pub. No.: US 2015/0348380 A1
(43) Pub. Date: Dec. 3, 2015

(54) ELECTRONIC APPARATUS AND SECURITY MANAGING METHOD

(71) Applicant: Kabushiki Kaisha Toshiba, Tokyo (JP)

(72) Inventor: Masahiro Takayama, Hachioji Tokyo (JP)

(21) Appl. No.: 14/539,771

(22) Filed: Nov. 12, 2014

Related U.S. Application Data
(60) Provisional application No. 62/003,914, filed on May 28, 2014.

(51) Int. Cl. G08B 13/14

(52) U.S. Cl. CPC G08B 13/14

(57) ABSTRACT

According to one embodiment, a wearable electronic apparatus includes a sensor and a processor. The sensor is configured to detect removal of the apparatus. The processor is configured to set the apparatus to be unusable when the removal of the apparatus is detected.

### CROSS-REFERENCE TO RELATED APPLICATIONS

This application claims the benefit of U.S. Provisional Application No. 62/003,914, filed May 28, 2014, the entire contents of which are incorporated herein by reference.

### FIELD

Embodiments described herein relate generally to security of a wearable electronic apparatus.

### BACKGROUND

Recently, various wearable devices have been developed by downsizing of information devices and their market has been widespread. At a wearable device, information suitable for the user is provided by using, for example, information concerning the user.

Information on the user's privacy such as the user's current position and biometric information is often used and a history of information viewed by the user is often stored in the wearable device.

Since the wearable device is shaped in eyeglasses or a wristwatch, the user can wear the wearable device or remove the wearable device from the user's body. For this reason, a third party may wear the removed wearable device and abuse the wearable device.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an appearance of an electronic apparatus (wearable device) of an embodiment.

FIG. 2 is an exemplary illustration for explaining an example of being detected that the electronic apparatus shown in FIG. 1 is removed.

FIG. 3 is an exemplary block diagram showing a system configuration of the electronic apparatus of the embodiment.

FIG. 4 is an exemplary block diagram showing a functional configuration of a security program executed by the electronic apparatus of the embodiment.

FIG. 5 is an exemplary flowchart showing procedures of security lock setting processing executed by the electronic apparatus of an embodiment.

FIG. 6 is an exemplary flowchart showing procedures of security lock releasing processing executed by the electronic apparatus of the embodiment.

### DETAILED DESCRIPTION

Various embodiments will be described hereinafter with reference to the accompanying drawings.

In general, according to one embodiment, a wearable electronic apparatus includes a sensor and a processor. The sensor is configured to detect removal of the apparatus. The processor is configured to set the apparatus to be unusable when the removal of the apparatus is detected.

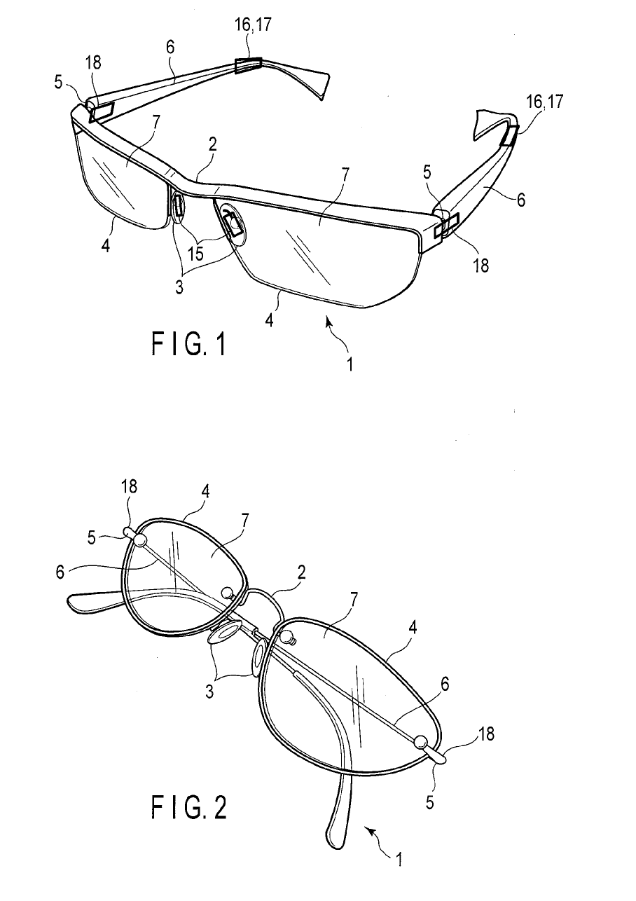

FIG. 1 is an exemplary perspective view showing an appearance of the electronic apparatus according to the embodiment. The electronic apparatus is a wearable device which can be attached to or removed from a user. The electronic apparatus can be implemented as a wearable device shaped in eyeglasses, a wristwatch, a bracelet, a ring, a belt, a necklace, contact lenses, etc.

A wearable device 1 is assumed to be used by, for example, a specific user that is a device owner, and can use information on user's privacy such as the user's current position and biometric information. The wearable device provides, for example, information requested by the user or information suitable for user's hobbies and tastes and user's current conditions (current position, date and time, etc.) as a text or an image displayed on a display, or voice output from a speaker or an earphone. In addition, the wearable device collects user's biometric information such as user's body heat, cardiac rate and blood pressure by, for example, a built-in biometric sensor, and provides information for health care based on the biometric information.

Implementation of the electronic apparatus as the eyeglass-type wearable device 1 will be hereinafter assumed.

The eyeglass-type wearable device 1 includes a bridge 2, nose pads 3, rims 4, hinges 5, temples 6, lenses 7, etc. as shown in FIG. 1. The nose pads 3 for fixing the eyeglasses by sandwiching a user's nose on both sides are attached to inside end portions of right and left rims 4 surrounding the lenses 7. In addition, the inside end portions of right and left rims 4 are connected to each other by the bridge 2.

Outside end portions of the rims 4 and one-side ends of the temples 6 are connected by the hinges 5, respectively. The rims 4 and the temples 6 can be folded at the hinges 5. For example, when the eyeglass-type wearable device 1 is removed or contained in a casing, the rims 4 and the temples 6 are folded at the hinges 5.

The wearable device 1 also includes a sensor configured to determine whether the user wears the wearable device 1 or has removed the wearable device 1. Weight sensors 15 configured to detect weight applied on the nose pads 3 are provided on the nose pads 3, respectively. For example, the wearable device 1 determines that the wearable device 1 is worn when the weight detected by the weight sensors 15 is equal to or greater than a first threshold value (smaller than the weight of the eyeglasses), and the wearable device 1 determines that the wearable device 1 has been removed when the weight is smaller than the first threshold value.

At a position of each temple 6 in contact with the user's face, a pressure sensor 16 configured to detect a pressure applied on the temple 6 and a temperature-humidity sensor 17 configured to detect temperature and humidity of the temple 6 are provided. The temperature-humidity sensors 17 may be provided on the nose pads 3. For example, the wearable device 1 determines that the wearable device 1 is worn when the pressure detected by the pressure sensors 16 is equal to or greater than a second threshold value, and the wearable device 1 determines that the wearable device 1 has been removed when the pressure is smaller than the second threshold value. In addition, the wearable device 1 determines that the wearable device 1 is worn when the temperature detected by the temperature-humidity sensors 17 is equal to or greater than a third threshold value and is smaller than a fourth threshold value, and the wearable device 1 determines that the wearable device 1 has been removed when the temperature is smaller than the third threshold value, or is equal to or greater than the fourth threshold value.

Sensors (switches) 18 configured to determine whether the rims 4 and the temples 6 are folded or not are provided on the hinges 5, respectively.

FIG. 2 shows an example of the appearance of the wearable device 1 in a case where the rims 4 and the temples 6 are folded at the hinges 5. The sensor 18 provided at each hinge 5 is, for example, a switch configured to output an ON signal when the rims 4 and the temples 6 are folded at the hinges 5 and to output an OFF signal (or to output no signals) when the rims 4 and the temples 6 are not folded. For example, the wearable device 1 determines that the wearable device 1 is worn when the OFF signal is output by the sensor (switch) 18, and determines that the wearable device 1 has been removed when the ON signal is output (or no signals are output).

Various components configured to input, output and process the data are built in each module of the wearable device 1. The components include, for example, a camera, a microphone, a speaker, a sensor, a display, a communication module, etc. for data input and output, and also include a CPU, a memory, etc. for data processing. The components may be built in the bridge 2, the nose pads 3, rims 4, the hinges 5, the temples 6, the lenses 7, etc. or may be attached to outside portions thereof.

Data input to or output from the wearable device 1 may be processed by the other electronic apparatus which can communicate with the wearable device 1 (for example, a tablet computer or a smartphone). The wearable device 1, for example, transmits image data taken by a camera to the other electronic apparatus and receives a processing result based on the image data, by using a communication module (for example, a communication module of 3G mobile communication, wireless LAN, Bluetooth®, etc.). In addition, the wearable device 1 also receives, for example, display data to be displayed on the display of the wearable device 1 from the other electronic device by using the communication module.

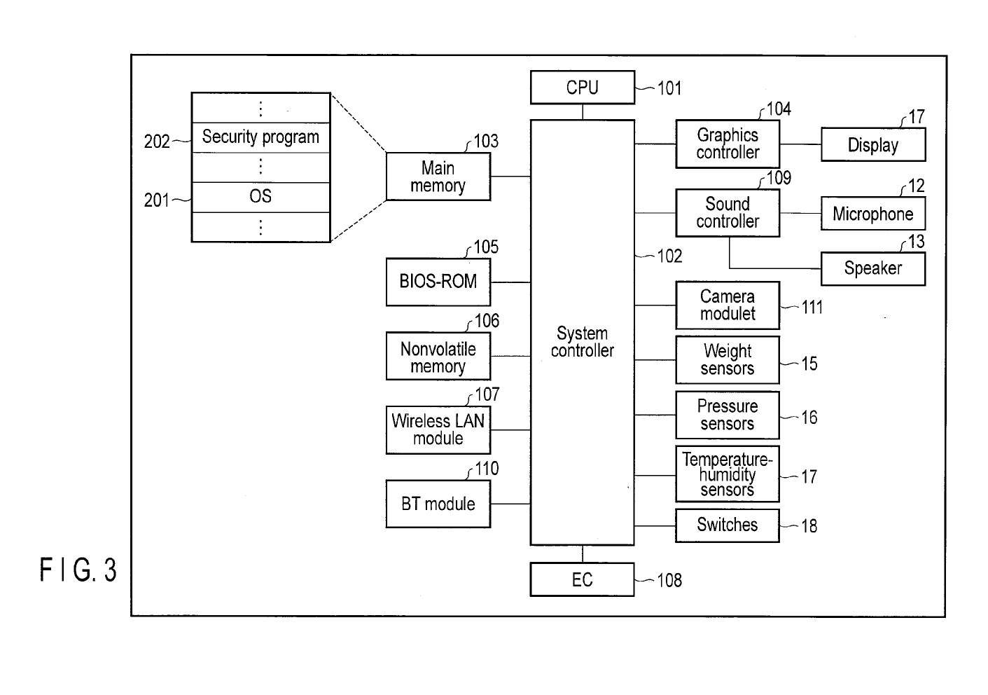

FIG. 3 is an exemplary diagram showing a system configuration of the wearable device 1.

The wearable device 1 includes a CPU 101, a system controller 102, a main memory 103, a graphics controller 104, a BIOS-ROM 105, a nonvolatile memory 106, a wireless LAN module 107, an embedded controller (EC) 108, a sound controller 109, a BT module 110, a camera module 111, the weight sensors 15, the pressure sensors 16, the temperature-humidity sensors 17, the switches 18, etc. as shown in FIG. 3.

The CPU 101 is a processor configured to control operations of the various components in the wearable device 1. The CPU 101 executes various types of software loaded from the nonvolatile memory 106 onto the main memory 103. The software includes an operating system (OS) 201 and various types of application programs. The application programs include a security program 202. The security program 202 includes a function of setting the wearable device 1 to be in a usable state or an unusable state.

In addition, the CPU 101 also executes a basic input output system (BIOS) stored in the BIOS-ROM 105. The BIOS is a program for hardware control.

The system controller 102 is a device configured to make connection between a local bus of the CPU 101 and each of the components. A memory controller configured to control access to the main memory 103 is built in the system controller 102. In addition, the system controller 102 includes a function of executing communication with the graphics controller 104 via a serial bus of PCI EXPRESS Standard.

The graphics controller 104 is a display controller configured to control a display 17 employed as a display monitor of the wearable device 1. A display signal generated by the graphics controller 104 is transmitted to the display 17. The display 17 displays a screen image based on the display signal.

The wireless LAN module 107 is a device configured to execute wireless LAN communication. The BT module 110 is a device configured to execute Bluetooth communication. In addition, a 3G module, i.e., a device configured to execute 3G mobile communication may also be provided.

The EC 108 is a single-chip microcomputer including an embedded controller for power management. The EC 108 includes a function of powering on or powering off the wearable device 1 in accordance with user's operations of a power button.

Since the wearable device 1 is shaped in eyeglasses, a wristwatch, etc., the user can easily wear or remove the wearable device 1. On the other hand, if the removed wearable device 1 is left carelessly, the wearable device 1 may be worn by a third party or may be abused by a third party.

For this reason, a security lock is set on the removed wearable device 1, in the present embodiment. Thus, the wearable device 1 can be prevented from being used illegally by a third party and the user's personal information can be prevented from leaking.

The security program 202 includes a function of setting the wearable device 1 to be in a usable state or an unusable state as described above. The security program 202 determines whether the wearable device 1 is worn or removed, by detecting a contact state (or a proximity state) of the wearable device 1 and the user by using, for example, various sensors such as the weight sensors 15, the pressure sensors 16 and the temperature-humidity sensors 17. A tactile sensor configured to detect contact or proximity to a human body, an olfactory sensor configured to measure (digitize) body odor, a myoelectric sensor configured to detect movement of muscles, etc. may be used as the sensors.

In addition, the security program 202 may determine whether the wearable device 1 is worn or removed, by detecting the folding at the hinges 5 by using, for example, the switches 18.

When the wearable device 1 is removed, the security program 202 sets the wearable device 1 to be unusable by, for example, setting a security lock of the wearable device 1.

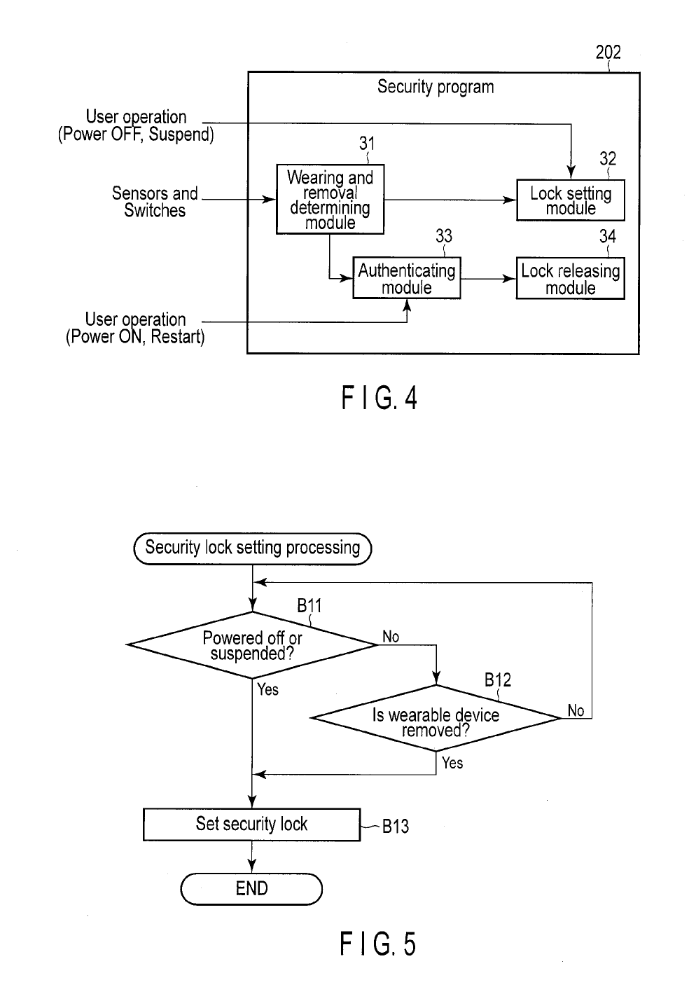

FIG. 4 shows an example of a functional configuration of the security program 202. The security program 202 sets or releases the security lock of the wearable device 1, based on the wearing or removal of the wearable device 1, and the user's operations of the wearable device 1. The security program 202 includes, for example, a wearing and removal determining module 31, a lock setting module 32, an authenticating module 33, and a lock releasing module 34.

First, the wearing and removal determining module 31 determines that the wearable device 1 has been removed. The wearing and removal determining module 31 determines whether the wearable device 1 is worn or removed by, for example, the sensors 15, 16 and 17 configured to detect the contact state or the proximity state of the wearable device 1 and the user, the switches 18 configured to determine that the wearable device 1 is folded at the hinges 5, etc. Several examples of the wearing and removal determining module 31 determining that the wearable device 1 is removed by the user, by the sensors, etc. will be hereinafter described.

The wearing and removal determining module 31 determines that the wearable device 1 is removed when the weight on the nose pads 3 of the wearable device 1 (eyeglasses) as detected by the weight sensors 15 is smaller than the first threshold value for a certain period. The first threshold value is smaller than, for example, the weight of the eyeglass-type wearable device 1.

The wearing and removal determining module 31 determines that the wearable device 1 is removed when the pressure on the temples 6 as detected by the pressure sensors 16 is smaller than the second threshold value for a certain period.

The wearing and removal determining module 31 determines that the wearable device 1 is removed when the contact temperature of the temples 6 (or the nose pads 3) as detected by the temperature-humidity sensors 17 is smaller than the third threshold value or is equal to or greater than the fourth threshold value. The third threshold value and the fourth threshold value are determined based on, for example, a range in which a temperature of a human body (body surface temperature) can fall, and the third threshold value is smaller than the fourth threshold value. In addition, the third threshold value and the fourth threshold value may be determined based on a range in which a body temperature of the user associated with the wearable device 1 (i.e., the owner of the wearable device 1) can fall.

The wearing and removal determining module 31 determines that the wearable device 1 is removed when, for example, the contact or proximity of the human body to the temples 6 (or the nose pads 3) is not detected by the tactile sensor.

The wearing and removal determining module 31 determines that the wearable device 1 is removed when a numerical value indicating the body odor detected by the olfactory sensor is smaller than a fifth threshold value. The fifth threshold value is determined based on, for example, a value which can be estimated as the numerical value indicating the odor of the human body. In addition, the fifth threshold value may be determined based on the numerical value indicating the body odor of the user associated with the wearable device 1.

The wearing and removal determining module 31 determines that the wearable device 1 is removed when, for example, movement of muscles on the temples 6 is not detected by the myoelectric sensor.

In addition, the wearing and removal determining module 31 determines that the wearable device 1 is removed when, for example, the folding at the hinges 5 (for example, a state in which the wearable device is folded and can be contained in a casing) is detected by the switches 18.

The wearing and removal determining module 31 can determine that the wearable device 1 is removed, by at least one of the sensors and the switches. In addition, the wearing and removal determining module 31 may determine that the wearable device 1 is removed, based on a combination of the detection results obtained by the sensors and the switches.

The lock setting module 32 sets the security lock of the wearable device 1 when the wearable device 1 is removed. The lock setting module 32 also sets the security lock of the wearable device 1 when the wearable device 1 is powered off or suspended. In other words, the lock setting module 32 sets the wearable device 1 to be unusable such that a third party cannot use the wearable device 1. When the wearable device 1 is set to be unusable, the wearable device 1 is set such that no data can be input or output by various user interfaces and is, for example, controlled such that no information can be displayed on the display or no speech can be output from the speaker. Furthermore, for example, the wearable device 1 is controlled to make no response even if the user operates a button, etc. provided on the wearable device 1. By setting the security lock, the wearable device 1 can be controlled to be unusable until user authentication is normally completed.

Then, the wearing and removal determining module 31 determines that the wearable device 1 set to be unusable is worn again. Several examples of the wearing and removal determining module 31 determining that the wearable device 1 is worn on the user, by the sensors, etc. will be hereinafter described.

The wearing and removal determining module 31 determines that the wearable device 1 is worn when, for example, the weight on the nose pads 3 of the wearable device 1 (eyeglasses) as detected by the weight sensors 15 is equal to or greater than the first threshold value for a certain period.

The wearing and removal determining module 31 determines that the wearable device 1 is worn when, for example, the pressure on the temples 6 as detected by the pressure sensors 16 is equal to or greater than the second threshold value for a certain period.

The wearing and removal determining module 31 determines that the wearable device 1 is worn when, for example, the contact temperature of the temples 6 (or the nose pads 3) as detected by the temperature-humidity sensors 17 is equal to or greater than the third threshold value and is smaller than the fourth threshold value.

The wearing and removal determining module 31 determines that the wearable device 1 is worn when, for example, the contact or proximity of the human body to the temples 6 (or the nose pads 3) is detected by the tactile sensor.

The wearing and removal determining module 31 determines that the wearable device 1 is worn when the numerical value indicating the body odor detected by the olfactory sensor is equal to or greater than the fifth threshold value.

The wearing and removal determining module 31 determines that the wearable device 1 is worn when, for example, the movement of the muscles on the temples 6 is detected by the myoelectric sensor.

In addition, the wearing and removal determining module 31 determines that the wearable device 1 is worn when, for example, the folding at the hinges 5 is not detected by the switches 18.

The wearing and removal determining module 31 can determine that the wearable device 1 is worn, by at least one of the sensors and the switches. In addition, the wearing and removal determining module 31 may determine that the wearable device 1 is worn, based on a combination of the detection results obtained by the sensors and the switches.

When the wearable device 1 is worn, the authenticating module 33 executes processing for authenticating (identifying) the user. The authenticating module 33 authenticates the user by executing, for example, biometrics authentication processing using user's iris, voice print, fingerprint, etc., and authentication processing using a Bluetooth authentication code with the other electronic device (for example, a tablet computer or a smartphone used by the user) preliminarily paired with the wearable device 1. In addition, the authenticating module 33 also executes the processing for authenticating the user, similarly, when the wearable device 1 is powered on or suspension of the wearable device 1 is canceled.

Then, the lock releasing module 34 releases the security lock of the wearable device 1 if the authentication is successful. In other words, the lock releasing module 34 sets the wearable device 1 to be usable such that the authenticated user can use the wearable device 1.

On the other hand, if the authentication is failed, the wearable device 1 remains unusable since the security lock of the wearable device 1 is not released. If a third party wears the wearable device 1 which is left unworn, the third party's illegal use can be therefore prevented since the wearable device 1 cannot be used.

In the above example, the eyeglass-type wearable device 1 has been described. However, the wearable device 1 can be designed to be in various shapes in which the user can wear (mount) such as a wristwatch, a bracelet, a ring, a belt, a necklace, and a contact lens.

If the wearable device 1 is, for example, in a wristwatch type, at least one of the pressure sensor 16, the temperature-humidity sensor 17, the tactile sensor, the olfactory sensor and the myoelectric sensor is provided at a belt portion of the wristwatch, and the contact state of the wearable device 1 and the user is detected by using the sensor. The wearing and removal determining module 31 thereby determines whether the user wears or removes the wristwatch-type wearable device 1. If the wearable device 1 is removed, the lock setting module 32 sets the wearable device 1 to be unusable (i.e., sets the security lock of the wearable device 1). If the wearable device 1 is set to be unusable, the wearable device 1 is controlled such that, for example, no information is displayed on the display or no speech is output from the speaker. Furthermore, the wearable device 1 is controlled to make no response if the user operates a button, etc. provided on the wearable device 1.

When the removed wearable device 1 is worn again, the authenticating module 33 executes the processing for authenticating the user. If the authentication is successful, the lock releasing module 34 sets the wearable device 1 to be usable (i.e., releases the security lock of the wearable device 1).

If the wearable device 1 is thus in the wristwatch type, a third party's use of the wearable device 1 can be prevented when the user removes the wearable device 1. Similarly, even if the wearable device 1 is in the other type, the wearable device 1 can be set to be unusable and a third party's use of the wearable device 1 can be prevented when the user removes the wearable device 1.

Next, an example of procedures of the security lock setting processing executed by the security program 202 will be described with reference to a flowchart of FIG. 5. It is hereinafter assumed that the user wears the wearable device 1 when the security lock setting processing is started.

First, the lock setting module 32 determines whether the wearable device 1 has been powered off or suspended (block B11). The lock setting module 32 determines whether, for example, a user operation for instructing powering off or suspension has been executed or not.

If the wearable device 1 is powered off or suspended (Yes in block B11), the lock setting module 32 sets the security lock of the wearable device 1 (block B13). By setting the security lock, the wearable device 1 is controlled to be unusable until the user authentication is normally completed.

If the wearable device 1 is not powered off or suspended (No in block B11), the wearing and removal determining module 31 determines whether the wearable device 1 has been removed or not (block B12). The removal of the wearable device 1 is determined based on, for example, at least one of elements that the weight on the nose pads 3 of the wearable device 1 (eyeglasses) is smaller than the first threshold value, that the wearable device 1 is folded at the hinges 5, that the pressure on the temples 6 is smaller than the second threshold value, and that the contact temperature of the nose pads 3 (or the temples 6) is smaller than the third threshold value or is equal to or greater than the fourth threshold value. If the wearable device 1 is removed (Yes in block B12), the lock setting module 32 sets the security lock of the wearable device 1 (block B13).

If the wearable device 1 is not removed (No in block B12), i.e., if the wearable device 1 is worn, the processing returns to block B11.

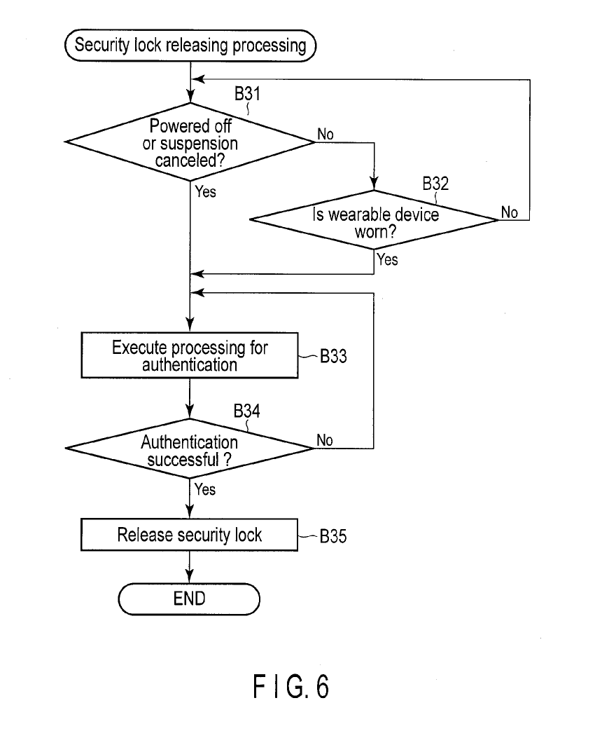

Next, an example of procedures of the security lock releasing processing executed by the security program 202 will be described with reference to a flowchart of FIG. 6. It is hereinafter assumed that the user does not wear, but removes the wearable device 1 when the security lock releasing processing is started.

First, the authenticating module 33 determines whether the wearable device 1 is powered on or the suspension of the wearable device 1 is canceled (block B31). The authenticating module 33 determines whether, for example, a user operation for instructing powering on or cancellation of the suspension is executed or not. If the wearable device 1 is not powered on or the suspension is not canceled (No in block B31), the wearing and removal determining module 31 determines whether the wearable device 1 is worn or not (block B32). The wearing of the wearable device 1 is determined based on, for example, at least one of elements that the weight on the nose pads 3 of the wearable device 1 (eyeglasses) is equal to or greater than the first threshold value, that the wearable device 1 is not folded at the hinges 5, that the pressure on the temples 6 is equal to or greater than the second threshold value, and that the contact temperature of the nose pads 3 (or the temples 6) is equal to or greater than the third threshold value and is smaller than the fourth threshold value.

If the wearable device 1 is not worn (No in block B32), i.e., if the wearable device 1 is removed, the processing returns to block B31.

If the wearable device 1 is powered on or the suspension is canceled (Yes in block B31) or if the wearable device 1 is worn (Yes in block B32), the authenticating module 33 executes the processing for authenticating the user (block B33). The authenticating module 33 authenticates the user by executing, for example, the biometrics authentication using user's iris, voice print, fingerprint, etc., and the authentication processing using the Bluetooth authentication code. Then, the lock releasing module 34 determines whether the user authentication of the wearable device 1 is successful or not (block B34). If the authentication is successful (Yes in block B34), the lock releasing module 34 releases the security lock of the wearable device 1 (block B35).

If the authentication is failed (No in block B34), the processing returns to block B33 and the processing for authentication is executed again. If the authentication is failed at more than a predetermined number of times, the processing may be ended without releasing the security lock.

As described above, in the present embodiment, if the user removes the wearable electronic device, a third party's use of the electronic device can be prevented. The wearing and removal determining module 31 determines that the wearable device 1 is removed, by the sensors 15-18. The lock setting module 32 sets the wearable device 1 to be unusable if it is detected that the wearable device 1 has been removed. Thus, the removed wearable device 1 can be prevented from being worn by a third party and the illegal use of the wearable device 1 can be prevented.

In addition, since various types of the processing of the present embodiment can be implemented by the computer program, the same advantage as that of the present embodiment can easily be obtained by installing the computer program via a computer-readable storage medium storing the computer program in a general computer and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wearable electronic apparatus, comprising:
a sensor configured to detect removal of the apparatus; and
a processor configured to set the apparatus to be unusable when the removal of the apparatus is detected.

2. The apparatus of claim 1, wherein the sensor is configured to detect the removal based on a contact state or a proximity state of a user and the apparatus.

3. The apparatus of claim 2, wherein:
the apparatus comprises an eyeglasses shape;
the sensor is configured to detect weight applied on a nose pad of the apparatus; and
the processor is configured to set the apparatus to be unusable when the weight is smaller than a first threshold value.

4. The apparatus of claim 2, wherein:
the apparatus comprises an eyeglasses shape;
the sensor is configured to detect pressure on a temple of the apparatus; and
the processor is configured to set the apparatus to be unusable when the pressure is smaller than a first threshold value.

5. The apparatus of claim 2, wherein:
the apparatus comprises an eyeglasses shape;
the sensor is configured to detect a temperature of at least one of the nose pad and the temple of the apparatus; and
the processor is configured to set the apparatus to be unusable when the temperature is smaller than a first threshold value or is equal to or greater than a second threshold value.

6. The apparatus of claim 1, wherein:
the electronic apparatus comprises an eyeglasses shape;
the sensor is configured to detect that the apparatus is folded at a hinge connecting a rim and a temple of the apparatus; and
the processor is configured to set the apparatus to be unusable when folding of the apparatus is detected.

7. The apparatus of claim 1, wherein:
the sensor is further configured to detect wearing of the apparatus set to be unusable; and
the processor is configured to authenticate a user when wearing of the apparatus is detected, and to set the apparatus to be usable when the user authentication is successful.

8. A security managing method of a wearable electronic apparatus, the method comprising:
detecting removal of the apparatus; and
setting the apparatus to be unusable when the removal is detected.

9. A computer-readable, non-transitory storage medium having stored thereon a computer program which is executable by a computer, the computer program controlling the computer to execute functions of:
detecting removal of the computer; and
setting the computer to be unusable when the removal is detected.
